(19) United States
(12) Patent Application Publication
(10) Pub. No.: US 2013/0115381 A1
(43) Pub. Date: May 9, 2013

(54) HYDROPHOBIC SURFACE COATING

(71) Applicants: David E. Schwartz, San Carlos, CA (US); Ricardo S. Roque, Sunnyvale, CA (US)

(72) Inventors: David E. Schwartz, San Carlos, CA (US); Ricardo S. Roque, Sunnyvale, CA (US)

(73) Assignee: PALO ALTO RESEARCH CENTER INCORPORATED, Palo Alto, CA (US)

(21) Appl. No.: 13/292,547

(22) Filed: Nov. 9, 2011

(51) Int. Cl. B05D 3/12; C09D 127/18; C09D 183/04; B05D 3/02; B05D 3/00; B82Y 99/00

(52) U.S. Cl. 427/535; 427/372.2; 427/565; 427/299; 427/240; 524/546; 524/588; 977/773

(57) ABSTRACT

Forming a hydrophobic layer on a surface can involve a mixture of a micropowder and a binder. The micropowder includes micrometer scale particles having diameters in a range of about 100 nm to about 50 μm. The mixture is applied to the surface and is cured. A majority or at least some of the micrometer scale particles have nanometer scale features having a feature size greater than about 25 nm and less than about 100 nm.

### FIELD

The present disclosure relates generally to hydrophobic and/or superhydrophobic surface coatings and methods for making such coatings.

### BACKGROUND

A hydrophobic, or non-wetting, surface is one on which a water droplet tends to form a bead, in contrast to a hydrophilic or wetting surface, on which water tends to form a film. The hydrophobicity of a surface can be characterized by the contact angle, θc, formed by a droplet 110 with respect to the surface 120, as shown in FIG. 1. A surface with a static water contact angle greater than 90° is called hydrophobic. Surfaces with contact angles greater than 150° are called superhydrophobic. Such surfaces are extremely non-wetting and have many applications for fluidic and microfluidic systems, protective and anti-fouling coatings, and/or self-cleaning surfaces.

### SUMMARY

Embodiments described in this disclosure relate to hydrophobic surface coatings. Some embodiments involve a method of forming a hydrophobic layer on a surface. A mixture is formed comprising a micropowder and a binder. The micropowder includes micrometer scale particles having diameters in a range of about 100 nm to about 50 μm. The mixture is applied to the surface and is cured. A majority or at least some of the micrometer scale particles have nanometer scale features having a feature size greater than about 25 nm and less than about 100 nm.

According to some aspects, a majority or at least some of the micrometer scale particles have a surface roughness less than about 25 nm.

For example, the micrometer scale particles can include one or more of metal microparticles, such as copper or silver, dielectric microparticles, such as silica or alumina, and polymer microparticles, such as polystyrene. In some cases, the micrometer scale particles form particle agglomerations that are larger than micrometer scale. The binder may be hydrophilic or hydrophobic. Suitable materials for the binder include one or more of a polymer, a silicone, and a fluoropolymer. For example, the binder may comprise polytetrafluoroethylene (PTFE) or polydimethylsiloxane (PDMS).

The mixture may be formed by mixing the micropowder and the binder in an ultrasonic bath.

The surface may be treated prior to coating to chemically activate and/or promote adhesion. For example, the surface may be treated by exposure to plasma or by silanization.

Application of the mixture to the surface can involve one or more of spin coating, dipping, and spraying. After application of the mixture, the coating may be cured, for example heat treating and/or drying.

Some embodiments involve a hydrophobic coating. The hydrophobic coating includes micrometer scale particles having a diameter of in a range of about 100 nm to about 50 μm and having surface features of between about 25 nm to about 100 nm and a binder configured to bind the micrometer scale particles to a surface.

The above summary is not intended to describe each embodiment or every implementation. A more complete understanding will become apparent and appreciated by referring to the following detailed description and claims in conjunction with the accompanying drawings.

### BRIEF DESCRIPTION OF THE DRAWINGS

FIG. 1 illustrates the contact angle formed by a droplet on a surface;

FIG. 2 shows a cross section of a structure that includes a hydrophobic coating comprising micrometer scale particles having nanometer scale features in accordance with embodiments described herein;

FIG. 3 shows a cross section of a structure that includes a hydrophobic coating comprising agglomerations of micrometer scale particles having nanometer scale features in accordance with embodiments described herein;

FIG. 4 shows a cross section of a structure that includes a hydrophobic coating comprising larger than micrometer scale particles having micrometer scale features and nanometer scale features in accordance with embodiments described herein;

FIG. 5 is a flow diagram of a method of making a hydrophobic coating in accordance with some embodiments;

FIG. 6 is a scanning electron microscope (SEM) image showing the nanometer scale surface features of a micrometer scale particle as discussed in some embodiments; and

FIG. 7 is an SEM image showing a coating in accordance with some embodiments.

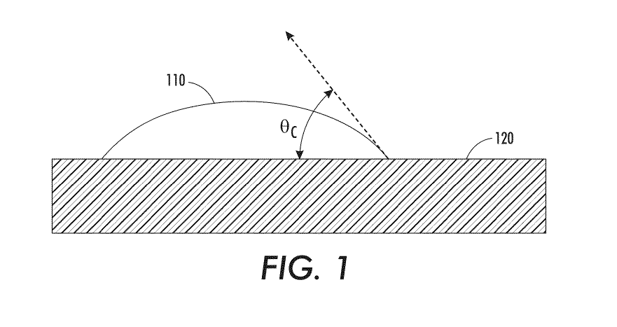

### DESCRIPTION OF VARIOUS EMBODIMENTS

Hydrophobic surfaces are water repellent and can exhibit a self-cleaning or “lotus leaf effect.” Surfaces that have both a micrometer scale and a nanometer scale roughness can exhibit these characteristics of hydrophobicity. Some approaches discussed below involve the formation of superhydrophobic coatings using a powder of micrometer scale or larger than micrometer scale particles.

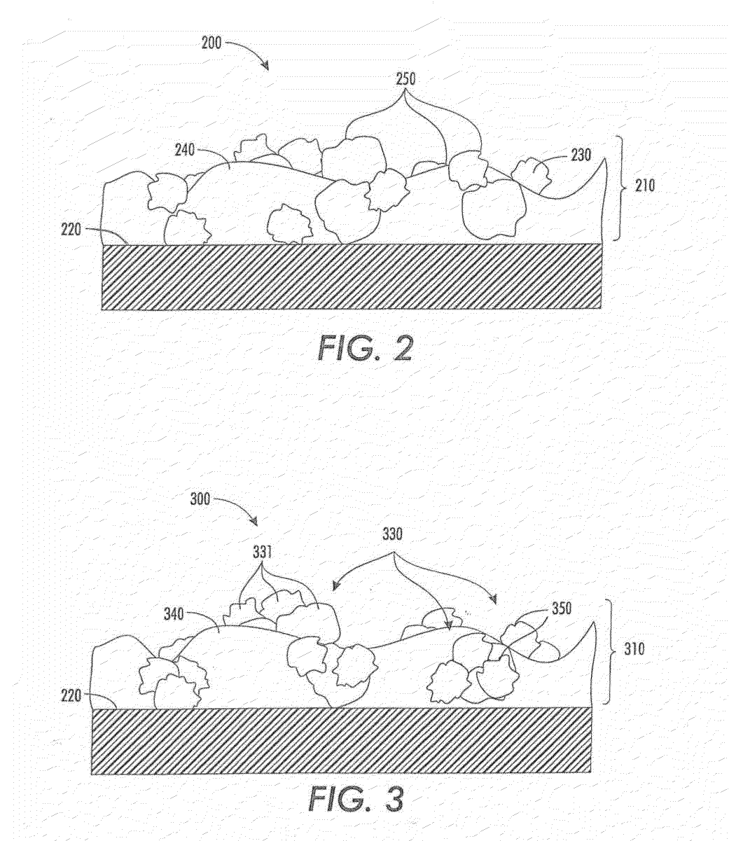

FIG. 2 shows a cross section of a structure 200 that includes a hydrophobic or superhydrophobic coating 210 disposed on a surface 220. The coating 210 includes a powder comprising micrometer scale particles 230 and a binder 240. For example, a majority of the particles 230 or substantially all of the particles 230 may have average diameters greater than about 100 nm or may have diameters in a range of about 100 nm to about 50 μm or in a range of about 100 nm to about 5 μm. In many cases, the binder 240 substantially or completely coats the particles 230.

The coating 210 may include particles that have a surface topography that includes sub-micrometer scale features 250, e.g., nanometer scale features, and/or the coating 210 may include particles may have substantially smooth surfaces. When present, the sub-micrometer scale features can provide a surface roughness of greater than about 25 nm or a surface roughness between about 25 nm to about 100 nm to the particles 230. For example, in some implementations, a majority of the particles or substantially all of the particles of the coating may have the sub-micrometer scale features. The micrometer scale particles 230 having sub-micrometer scale features provide the micrometer scale and nanometer scale roughness associated with hydrophobicity.

In some configurations, as depicted by the structure 300 of FIG. 3, the coating 310 may include agglomerations 330 of micrometer scale particles 331 and a binder 340. The agglomerations 330 themselves may be larger than micrometer scale. A particle agglomeration 330 has a micrometer scale surface topography imparted by the multiple micrometer scale particles 331 that form the agglomeration 330. A majority of the particles or substantially all of the particles in the agglomerations 330 may have average diameters greater than about 100 nm or in a range of about 100 nm to about 50 μm or in a range of about 100 nm to about 5 μm. The micrometer scale particles 331 may have sub-micrometer scale, e.g., nanometer scale, surface features 350 and/or may be substantially smooth. When present, the nanometer scale surface features 350 provide sub-micrometer scale surface roughness as previously discussed in connection with FIG. 2. The sub-micrometer scale features 350 can provide a surface roughness of greater than about 25 nm or a surface roughness between about 25 nm to about 100 nm to the agglomerations 330. The agglomerations 330 provide both the micrometer scale and nanometer scale roughness associated with hydrophobic surfaces. According to some aspects, particles forming the agglomerations may be sintered together or otherwise adhered to one another.

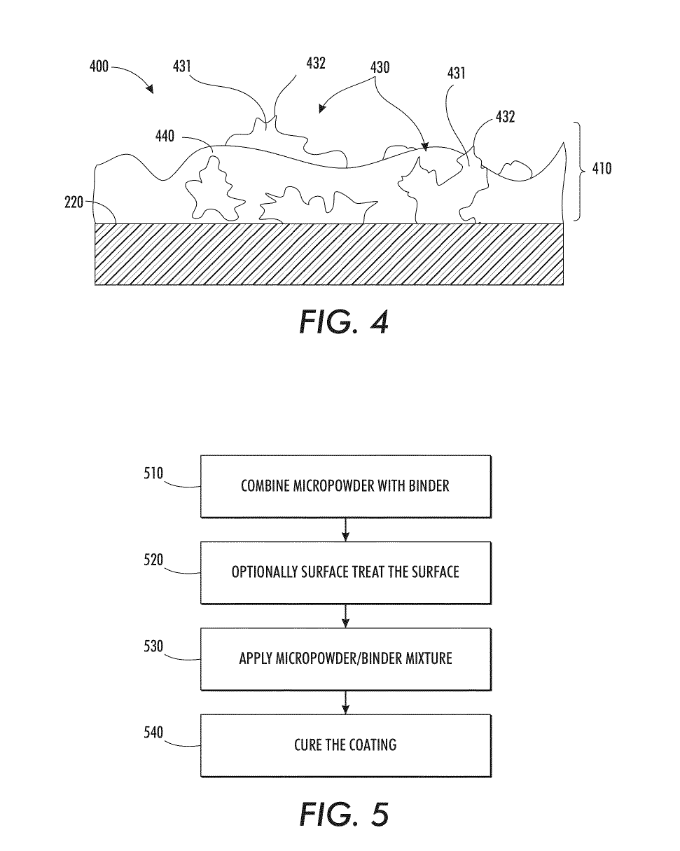

FIG. 4 illustrates a structure 400 having a coating 410 comprising a binder 440 and particles 430. The particles 430 of the coating 410 may be larger than micrometer size and may comprise micrometer scale features 431. The micrometer scale features 431 may have sub-micrometer scale, e.g., nanometer scale, features 432 disposed thereon, or may be substantially smooth. The micrometer scale features 431 may have average dimensions of greater than about 100 nm or in a range of about 100 nm to about 50 μm or in a range of about 100 nm to about 5 μm. The sub-micrometer scale features 432 disposed on the micrometer scale features 431 can provide a surface roughness of greater than about 25 nm or a surface roughness between about 25 nm to about 100 nm to the particles 430.

FIG. 5 is a flow diagram of a process for forming a hydrophobic coating. A micropowder is combined 510 with a binder. The micropowder can include particles having irregular surface features. As discussed above, the particles may comprise one or more of a) micrometer scale particles with nanometer scale features, b) micrometer scale particles with smooth surfaces, c) agglomerations of micrometer scale particles with nanometer scale features or smooth surfaces, and/or d) larger than micrometer scale particles with micrometer scale features and nanometer scale features. The particles may comprise metal particles, such as copper or silver particles, dielectric particles, such as silica or alumina particles, polymer particles, such as polystyrene particles and/or any other type of particles in a size range of about 100 nm to about 50 μm. Alternatively or additionally, the particles may be larger than 50 μm with micrometer scale features. The type of particles used in the micropowder will depend on the application. For example, some types of polymer particles have a low melting temperature that may not be compatible with some applications and conductive metal particles might interfere with applications that involve electricity.

In some cases, the binder may comprise a liquid hydrophobic binder, or a liquid hydrophobic polymer, such as polytetrafluoroethylene (PTFE) in solution. In some cases, the binder may be weakly hydrophobic or even hydrophilic. The binder may comprise a fluoropolymer, or a silicone, such as polydimethylsiloxane (PDMS).

To achieve a substantially uniform distribution of particles, the micropowder and the binder may be mixed for a period of time, such as in an ultrasonic bath. The use of a binder imparts various features to the coating. If the binder is itself hydrophobic (e.g., PTFE), the binder serves to increase the hydrophobicity of the textured surface. Furthermore, for any type of binder, the binder enhances adhesion of the particles to the surface when compared, for example, to adhering the particles by solvating the surface. The binder provides enhanced adhesion properties because the total contact area between the binder and the surface is much greater than the tangential contact points between the individual particles and the surface, which would be the adhesion points for solvated surface adhesion.

Depending on the surface being coated, optionally the surface of the surface may be prepared 520 to promote adhesion of the coating. For example, a brief oxygen plasma treatment can improve the adhesion of PTFE to glass. Other methods can be used for surface preparation for the PTFE/glass or other mixture/surface combinations. For example, in some implementations, it is helpful to chemically activate the surface, such as through silanization, which can enhance adhesion of some polymers to glass. Silanization can involve the use of organofunctional alkoxysilane molecules which, through self-assembly, cover a surface and promote adhesion.

In some implementations, an initial layer, e.g., a PTFE layer without the microparticles, may be disposed on the surface prior to the coating. The surface is coated 530 with the mixture, for example, by spraying, spin coating or dipping. The coating is cured 540 by a method appropriate for the particular material, e.g., by baking, or by allowing to dry at room temperature UV polymerization, etc. For example, a PTFE binder can be cured by baking it above (or not above) its glass transition temperature. In some cases, the coating can be cured by baking at about 100 C for about 20 min, for example.

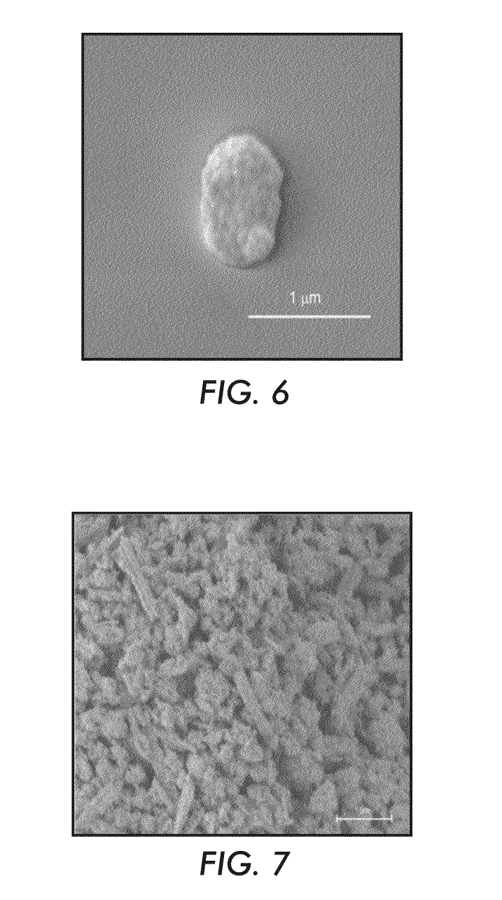

FIG. 6 is scanning electron microscope (SEM) image of a micrometer scale copper particle having nanometer scale features. FIG. 7 shows a SEM image of 12% (wt) copper micropowder (available from American Elements®, www.americanelements.com) in Teflon AF (available from DuPont, www.dupont.com). Both micrometer and sub-micrometer scale features can be seen in FIGS. 6 and 7 Measurements show static water contact angles of approximately 150° for silver 7% (wt) silver micropowder in Teflon AF.

### EXAMPLE

A glass die was cleaned in acetone, isopropyl alcohol, and de-ionized (DI) water. Next, the glass diet was placed in an oxygen plasma at 350 W for 5 min at 0.3 Ton to further clean as well as activate the surface. A first layer of Teflon AF (available from Du Pont) with a glass transition temperature of 240 C was spin coated at 1200 RPM for 60 s. The sample was then placed on a hot plate at 295 C for 45 min and subsequently cooled to room temperature on a brass heat sink. Silver microparticles (available from American Elements) suspended in Teflon solution at 13% wt. This second solution was then spin coated at 1200 RPM for 60 s. The sample was then heated and cooled again. This yielded a sessile contact angle of 153°.

In the detailed description, numeric values and ranges are provided for various aspects of the implementations described. These values and ranges are to be treated as examples only, and are not intended to limit the scope of the claims. For example, embodiments described in this disclosure can be practiced throughout the disclosed numerical ranges. In addition, a number of materials are identified as suitable for various facets of the implementations. These materials are to be treated as exemplary, and are not intended to limit the scope of the claims.

Systems, devices or methods disclosed herein may include one or more of the features, structures, methods, or combinations thereof described herein. For example, a device or method may be implemented to include one or more of the features and/or processes described below. It is intended that such device or method need not include all of the features and/or processes described herein, but may be implemented to include selected features and/or processes that provide useful structures and/or functionality. The description of various embodiments has been presented for the purposes of illustration and description and not limitation. The embodiments disclosed are not intended to be exhaustive or to limit the possible implementations to the embodiments disclosed. Many modifications and variations are possible in light of the above teaching.

1. A method of forming a hydrophobic layer, comprising
forming a mixture of a micropowder with a binder, the micropowder comprising micrometer scale particles having diameters in a range of about 100 nm to about 50 μm, at least some of the micrometer scale particles have nanometer scale features having a feature size greater than about 25 nm and less than about 100 nm;
applying the mixture to a surface; and
curing the mixture.

2. The method of claim 1, wherein a majority of the micrometer scale particles have nanometer scale features having a feature size greater than about 25 nm and less than about 100 nm.

3. The method of claim 1, wherein a majority of the micrometer scale particles have a surface roughness less than about 25 nm.

4. The method of claim 1, wherein the micrometer scale particles comprise at least one of
metal microparticles,
dielectric microparticles, and
polymer microparticles.

5. The method of claim 1, wherein the binder comprises a polymer.

6. The method of claim 5, wherein the polymer comprises polytetrafluoroethylene (PTFE).

7. The method of claim 1, wherein the binder is hydrophilic.

8. The method of claim 1, wherein the binder is hydrophobic.

9. The method of claim 1, wherein forming the mixture comprises mixing the micropowder and the binder in an ultrasonic bath.

10. The method of claim 1, further comprising treating the surface prior to the coating.

11. The method of claim 10, wherein treating the surface comprises one or more of plasma treating the surface and silanization of the surface.

12. The method of claim 1, wherein applying the mixture to the surface involves one or more of spin coating, dipping, and spraying.

13. The method of claim 1, wherein the binder comprises a fluoropolymer.

14. The method of claim 1, wherein the binder comprises a silicone.

15. The method of claim 1, wherein the binder comprises polydimethylsiloxane (PDMS).

16. The method of claim 1, wherein curing comprises at least one of heat treating and drying.

17. The method of claim 1, wherein the micrometer scale particles form particle agglomerations.

18. A hydrophobic coating, comprising:
micrometer scale particles having a diameter of in a range of about 100 nm to about 50 μm, at least some of the micrometer scale particles having surface features of between about 25 nm to about 100 nm; and
a binder configured to bind the micrometer scale particles to a surface.

19. The coating of claim 18, wherein the micrometer scale particles form agglomerations.

20. The coating of claim 18, wherein the binder is hydrophobic.

21. The coating of claim 18, wherein the binder is hydrophilic.

22. The coating of claim 18, wherein at least some of the micrometer scale particles have surface features less than about 25 nm.

23. The coating of claim 18, wherein the binder substantially covers the micrometer scale particles.
